(19) United States
(12) Patent Application Publication
(10) Pub. No.: US 2012/0282460 A1
(43) Pub. Date: Nov. 8, 2012

(54) CHEMICAL FIBER WITH RAPID TEMPERATURE-RISING AND HEATING EFFECT UNDER CONDITIONS OF LIGHT AND TEXTILE CONTAINING THE SAME

(76) Inventor: Yingjun Mao, Shanghai (CN)

(21) Appl. No.: 13/512,263

(22) PCT Filed: Jan. 8, 2010
(86) PCT No.: PCT/CN2010/000033

§ 371 Date: May 25, 2012

(30) Foreign Application Priority Data
Nov. 26, 2009 (CN) 200910224268.2

(51) Int. Cl. B32B 15/02; B32B 5/02; B32B 15/14; C09K 3/00

(52) U.S. Cl. 428/338; 252/70

(57) ABSTRACT

A chemical fiber which has rapid temperature-rising and heating effect under conditions of light and a textile product which contains the said chemical fiber are provided. The chemical fiber includes conventional chemical fibers and 0.1-3 weight % of nano units. The nano units include microparticles with the size of 300-8000 nanometers, and the microparticles include at least one of Si, Zn, Ca, Mg, Na, Fe or the mixture thereof. Because of the addition of the nano units of microparicles with the size of 300-8000 nanometers to the conventional chemical fibers, the chemical fiber possesses unexpected rapid temperature-rising effect when contacted with light under the same time and intensity of light irradiation.

### CROSS-REFERENCE TO RELATED APPLICATION

This application is a Section 371 National Stage Application of International Application No. PCT/CN2010/000033, filed Jan. 8, 2010, which is incorporated by reference in its entirety and published as WO 2011/063589 on Jun. 3, 2011, not in English, which claims priority to and benefits of Chinese Patent Application Serial No. 200910224268.2, filed with the State Intellectual Property Office of P. R. China on Nov. 26, 2009, the entire content of which is incorporated herein by reference.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD

The present disclosure relates to a chemical fiber, and more particularly to a chemical fiber with rapid temperature-rising and heating effect under conditions of light and a textile containing the same.

### BACKGROUND

Heat preservation of a conventional fiber and a conventional textile is mainly to prevent heat generated by a body from escaping. With the development of sciences, a part of fibers having heating function have been developed by people. For example:

1. Electrothermal Fiber

An insulating garment material trial-produced by Japan is a composite fiber using electrothermal materials. The principle of the insulating garment material is similar to that of an electric blanket, and is to heat a fiber by energizing a conductive fiber so as to achieve heating effect. A garment made of this fiber has an appearance similar to that of a thin unlined garment, but is actually an electrothermal garment. The energy source of the garment is a portable chargeable battery, which provides enough inexhaustible heat in cold winter to protect against the cold.

Defects of this electrothermal fiber are high manufacture cost, power supply which needs a portable chargeable battery, and large use inconvenience in daily lives.

2. Sun Velvet

A sun velvet is a new-generation representative material manufactured according to the principle of a space cotton. The sun velvet is manufactured by texturing and shagging a conventional 100% wool fiber, and then placing the wool fiber between two layers of soft mirror surfaces so as to form a thermal convection barrier layer (an airbag) of controllable thickness, which has very low coefficient of thermal conductivity and has reflection action on heat rays of the body so as to achieve double heat preservation effects. Because the content of a gas in the airbag is 90%, the sun velvet is not only light and soft, but also warm. The amount of fiber in a unit volume of the sun velvet is smaller than that in a unit volume of the cotton by ⅔, and smaller than that in a unit volume of the down feather by ⅘, and consequently the garment made of the sun velvet is beautiful but not clumsy. After inspected, the CLO value of the sun velvet is 3.062. Micropores which may be opened and closed are formed in two layers of mirror surfaces, and like pores of the skin, may be opened for heat dissipation when the micropores are hot and may be closed for heat preservation when the micropores are cold. The temperature of the sun velvet may be adjusted, the sun velvet has gas permeability, and consequently is an ideal garment material in autumn and winter.

Defects of this sun velvet are complex manufacture process, high cost, difficulty in industrialization, and so on.

3. Chemical Insulating and Temperature-Adjusting Fiber

An insulating and temperature-adjusting fiber is manufactured chemically by some people. For example, a sodium sulfate textile is packed in a membrane attached with a waterproof layer. When sodium sulfate is heated, sodium sulfate is liquefied for heat storage, which has a heat storage capacity higher than that of water by 60 times, thus reducing body temperature. When sodium sulfate is cooled, sodium sulfate is solidified and dissipates absorbed heat.

After a textile is made of this material, the fiber may be leaked due to various scratching and collisions in daily lives. Therefore, the practicality of the chemical insulating and temperature-adjusting fiber needs to be further improved.

### SUMMARY

The present disclosure is directed to overcome the above defects existing in the prior art. Accordingly, an object of the present disclosure is to provide a chemical fiber with rapid temperature-rising and heating effect under conditions of light, which may be convenient to manufacture, low in cost, and easy to implement industrially.

In order to achieve the above object, the following solution is used by the present disclosure.

A chemical fiber with rapid temperature-rising and heating effect under conditions of light comprises a conventional chemical fiber and 0.1-3 wt % of a nano unit, in which the nano unit comprises microparticles with a particle size of 300-8000 nanometers, and the microparticles comprise mainly Si, Zn, Ca, Mg, Na, Fe, or a mixture thereof. The microparticles may be any one of Si, Zn, Ca, Mg, Na and Fe, or a mixture of Si, Zn, Ca, Mg, Na and Fe in any proportion.

Advantageously, the chemical fiber comprises 2-3 wt % of microparticles with a particle size of 300-2000 nanometers. Further, the microparticles comprises 40-50 wt % of Si, 20-30 wt % of Zn, and 20-40 wt % of a mixture of Ca, Mg, Na and Fe.

Advantageously, the chemical fiber comprises 1-2 wt % of microparticles with a particle size of 2000-5000 nanometers. Further, the microparticles comprises 40-50 wt % of Si, 20-30 wt % of Zn, and 20-40 wt % of a mixture of Ca, Mg, Na and Fe.

Advantageously, the chemical fiber comprises 0.1-1 wt % of microparticles with a particle size of 5000-8000 nanometers. Further, the microparticles comprises 40-50 wt % of Si, 20-30 wt % of Zn, and 20-40 wt % of a mixture of Ca, Mg, Na and Fe.

Another object of the present disclosure is to provide a textile with rapid temperature-rising and heating effect under conditions of light. The textile at least comprises a part of the chemical fiber described above.

The present disclosure has the following advantages.

Because of the addition of the nano unit of microparicles with a particle size of 300-8000 nanometers to the conventional chemical fiber, the chemical fiber of the present disclosure has unexpected rapid temperature-rising effect when contacted with light under the same light irradiation time and the same light irradiation intensity. Compared with a conventional heating fiber, the present disclosure has advantages of low cost, simple manufacture process, easy industrial production, and so on, and it is a novel heating fiber material which is better to be used in a low-temperature environment.

### BRIEF DESCRIPTION OF THE DRAWINGS

FIG. 1 is a diagram of an inspection device according to an embodiment of the present disclosure;

FIG. 2 shows a temperature-time curve of a measuring method in Embodiment 1.

### DETAILED DESCRIPTION

### Embodiment 1

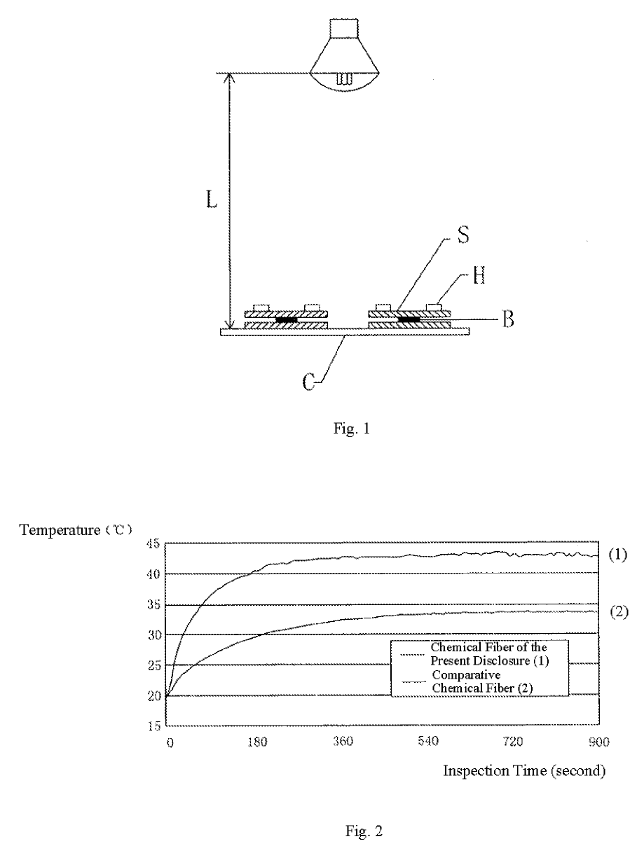

Referring to FIG. 1, an inspection embodiment of the chemical fiber with rapid temperature-rising and heating effect under conditions of light of the present disclosure is shown.

Inspection organization: Japan Synthetic Textile Inspection Institute Foundation

Number of inspection certificate: CK-64215-2

Inspection item: determination of heat storage efficiency

1. Inspection Samples

(1) Chemical fiber of the present disclosure: About 1.5 wt % of a nano unit was added to a conventional chemical fiber. The nano unit comprises microparticles with a particle size of about 3000 nanometers, and the microparticles comprise 45 wt % of Si, 25 wt % of Zn, 30 wt % of a mixture of Ca, Mg, Na and Fe, and other trace elements. The nano unit may be added in the fiber manufacture process using any one of conventional techniques.

(2) Comparative chemical fiber: a conventional chemical fiber not containing a nano unit.

2. Inspection Method:

Using a temperature-time curve, a layered fiber sample was placed on a polystyrene foam table C and fixed using a fixture H, and then recording was performed under the following light irradiation conditions/ways (see FIG. 1) by a method of inserting a thermocouple thermometer B between two layers of inspection samples S.

In addition, the measuring method is to measure by changing the measured position of each sample. Moreover, the same calculation mode is used by two measuring methods to obtain corresponding inspection results.

Light Irradiation Conditions/Ways:

Light source: an electric lamp A with a voltage of 100 V and a power of 500 W available from Iwasaki Electric Co., Ltd.;

Irradiation distance L: 50 cm;

Irradiation position: a surface of each inspection sample;

Irradiation time: 15 minutes;

Air temperature: 20±2° C.

3. The inspection results of the above samples are as follows:

### Inspection Results (° C.)

| | Chemical Fiber of the | Comparative |
|---|---|---|
| Inspection Time (second) | Present Disclosure (1) | Chemical Fiber (2) |
| 0 | 19.6 | 19.6 |
| 30 | 29.5 | 23.3 |
| 60 | 33.5 | 25.1 |
| 120 | 38.0 | 27.8 |
| 300 | 42.3 | 31.7 |
| 600 | 43.0 | 33.5 |
| 900 | 42.8 | 33.7 |

The temperature-time curve of the above inspection results is shown in FIG. 2.

It may be seen from the above inspection results by Japan Synthetic Textile Inspection Institute Foundation that, under the same light irradiation time and the same light irradiation intensity, compared with the conventional chemical fiber, the chemical fiber with rapid temperature-rising and heating effect under conditions of light of the present disclosure has more significant and unexpected rapid temperature-rising effect.

### Embodiment 2

This embodiment is different from the above embodiment in that the chemical fiber comprises 2.8 wt % of microparticles with a particle size of about 500 nanometers. The microparticles comprise 40 wt % of Si, 20 wt % of Zn, 40 wt % of a mixture of Ca, Mg, Na and Fe, and other trace elements.

The inspection results of the above samples are as follows:

### Inspection Results (° C.)

| | Chemical Fiber of the | Comparative |
|---|---|---|
| Inspection Time (second) | Present Disclosure (1) | Chemical Fiber (2) |
| 0 | 19.6 | 19.6 |
| 30 | 29.8 | 23.3 |
| 60 | 34.1 | 25.1 |
| 120 | 39.5 | 27.8 |
| 300 | 43.7 | 31.7 |
| 600 | 44.1 | 33.5 |
| 900 | 44.5 | 33.7 |

The temperature-time curve of the above inspection results in this embodiment: omitted.

### Embodiment 3

This embodiment is different from the above embodiments in that the chemical fiber comprises 0.7 wt % of microparticles with a particle size of about 7000 nanometers. The microparticles comprise 50 wt % of Si, 30 wt % of Zn, 20 wt % of a mixture of Ca, Mg, Na and Fe, and other trace elements.

The inspection results of the above samples are as follows:

### Inspection Results (° C.)

| | Chemical Fiber of the | Comparative |
|---|---|---|
| Inspection Time (second) | Present Disclosure (1) | Chemical Fiber (2) |
| 0 | 19.6 | 19.6 |
| 30 | 29.3 | 23.3 |
| 60 | 33.2 | 25.1 |
| 120 | 37.8 | 27.8 |
| 300 | 42.0 | 31.7 |
| 600 | 42.5 | 33.5 |
| 900 | 42.3 | 33.7 |

The temperature-time curve of the above inspection results in this embodiment: omitted.

Because of limitation of a conventional textile process, in the present disclosure, 0.1-3 wt % of a nano unit comprising microparticles with a particle size of 300-8000 nanometers is added to a conventional chemical fiber so as to allow the novel chemical fiber to have unexpected rapid temperature-rising and heating effect when contacted with light. However, it would be appreciated by those skilled in the art that on condition of allowance by the textile process, more weight portions of a nano unit comprising microparticles with a smaller particle size may be added so as to form a chemical fiber with better heating effect.

In addition, another object of the present disclosure is to provide a textile with rapid temperature-rising and heating effect under conditions of light, for example, knitting products and tatting products. The textile at least comprises a part of the chemical fiber described above. Certainly, the textile may be wholly made of the chemical fiber with rapid temperature-rising and heating effect under conditions of light of the present disclosure.

Obviously, it would be appreciated by those skilled in that art that the chemical fiber with rapid temperature-rising and heating effect under conditions of light of the present disclosure may be used to form various types of heating fibers.

The above embodiments are merely used to illustrate the present disclosure, but shall not be construed to limit the present disclosure. It would be appreciated by those skilled in the art that changes and modifications may be made in the embodiments without departing from scope of the present disclosure. Therefore, all the equivalent technical solutions should also fall into the scope of the present disclosure. The scope of the present disclosure should be defined by the claims.

1. A chemical fiber with rapid temperature-rising and heating effect under conditions of light, comprising a conventional chemical fiber and 0.1-3 wt % of a nano unit,
wherein the nano unit comprises microparticles with a particle size of 300-8000 nanometers, and the microparticles comprise mainly Si, Zn, Ca, Mg, Na, Fe, or a mixture thereof.

2. The chemical fiber according to claim 1, comprising 2-3 wt % of microparticles with a particle size of 300-2000 nanometers.

3. The chemical fiber according to claim 2, wherein the microparticles comprises 40-50 wt % of Si, 20-30 wt % of Zn, and 20-40 wt % of a mixture of Ca, Mg, Na and Fe.

4. The chemical fiber according to claim 1, comprising 1-2 wt % of microparticles with a particle size of 2000-5000 nanometers.

5. The chemical fiber according to claim 4, wherein the microparticles comprises 40-50 wt % of Si, 20-30 wt % of Zn, and 20-40 wt % of a mixture of Ca, Mg, Na and Fe.

6. The chemical fiber according to claim 1, comprising 0.1-1 wt % of microparticles with a particle size of 5000-8000 nanometers.

7. The chemical fiber according to claim 6, wherein the microparticles comprises 40-50 wt % of Si, 20-30 wt % of Zn, and 20-40 wt % of a mixture of Ca, Mg, Na and Fe.

8. A textile with rapid temperature-rising and heating effect under conditions of light, wherein the textile comprises:
a conventional chemical fiber; and
0.1-3 wt % of a nano unit, wherein the nano unit comprises microparticles with a particle size of 300-8000 nanometers, and the microparticles comprise at least one of Si, Zn, Ca, Mg, Na, Fe, or a mixture thereof.
